(19) United States
(12) Patent Application Publication
(10) Pub. No.: US 2010/0101350 A1
(43) Pub. Date: Apr. 29, 2010

(54) TWO-COMPONENT GEAR WHEEL

(76) Inventor: Achim Hawighorst, Buehlertal (DE)

Correspondence Address: MERCHANT & GOULD PC, P.O. BOX 2903, MINNEAPOLIS, MN, 55402-0903, US

(21) Appl. No.: 12/528,762

(22) PCT Filed: Jan. 8, 2008
(86) PCT No.: PCT/EP08/50143

§ 371 Date: Aug. 26, 2009

(30) Foreign Application Priority Data
Feb. 27, 2007 (DE) 10 2007 009 564.5

(51) Int. Cl. F16H 55/17

(52) U.S. Cl. 74/434

(57) ABSTRACT

The invention relates to a two-component gear wheel, comprising a metal formed part (1) made of a gear rim (2) with outer gearing and at least one supporting element (4), which is connected to the gear rim (2) on the inside of the gear rim (2), and a plastic filling (5), which has planar contact at least in some regions with the inside of the gear rim (2).

The invention relates to a two-component gear wheel, which is composed of parts from at least two different materials. Such gear wheels are suited in particular for use in wiper drives of motor vehicles.

### TECHNICAL FIELD

Gear wheels constitute important gear-unit components and are subject to extremely different demands. As a rule, care must be taken to provide a sufficient surface rigidity of the gear body besides a sufficient stability of the gear wheel. On the other hand, in other configurations no particular demands are placed on an increased surface rigidity, whereas aspects of the wear in the region of the tooth flanks and aspects of the fixing and/or the guidance of the gear wheels on axles or shafts represent limiting factors. This is particularly the case of gear units, in which an increased friction power occurs between surfaces of gearing elements, which are positively locking, meshing and displaceable. This is, for example, the case with worm gear units, in particular in wiper drives.

It is known how to manufacture gear wheels from massive plastic, from massive metal, from sintered metal or from metal with diverse surface coatings. Gear wheels from massive metal or sintered metal indeed meet high strength requirements but have, however, as disadvantages relatively high material costs and a high dead weight. In the case of gear wheels from massive plastic, the abrasion resistance in the region of the tooth flanks often represents a limiting factor. An additional factor is an increased thermal sensitivity, which in the case of suddenly occurring thermal overload can lead to irreversible deformations, respectively to the destruction of such gear wheels.

### SUMMARY

The invention relates to a two-component gear wheel, which is based on a combination of different materials. It comprises a preferably metallic formed part, which has a gear rim, which has an outer geometry predefined by gear unit components interacting with the gearing wheel according to the invention. In addition, the formed part has at least one supporting element running into the interior region of the gear rim. A connection of the gear rim to a plastic material in the form of a dimensionally stable plastic filling can result via said supporting element. The plastic material can thereby be provided in the form of a pourable filling or in the form of a plastic formed part. It serves in each case to fill the interior region of the gear rim and assumes at least partially the function of a conventional wheel body. This function consists of establishing the position of the gear rim relative to the axle or shaft carrying the gear wheel, of stabilizing the gear rim under load and of transferring forces and moments in the flow of forces within the gear arrangement comprising the gear wheel. The innovative configuration of a gear wheel comprising two components allows the advantages of a plurality of gear types to combine and allows different disadvantages of the state of the art to be avoided. First of all, the high percentage of plastic of a gear wheel according to the invention reduces the weight and the manufacturing costs. At the same time, the gear rim of the metallic formed part has characteristics of massive metal gears in the region of the tooth flanks, which has a positive effect on wear and service life. Moreover, a gear wheel configured in this way is in comparison to pure plastic gear wheels significantly more insensitive to short-time thermal loads, which are regionally introduced into the gear wheel via the gear rim. Such thermal loads can, for example, occur in wiper drives with a worm drive if the heat of the electrical motor that is heating up is introduced into the gear rim of a spur gear through a blockage of the wiper system via a worm sitting on the armature shaft of an electrical motor.

The invention is embodied by a two-component gear wheel comprising a metallic formed part consisting of a gear wheel with outer gearing and at least one supporting element, which is connected to the gear rim on the inside of said gear rim, and a plastic filling, which has planar contact at least partially with the inside of the gear rim. The metallic formed part according to the invention can be manufactured as a cast part (for example: an aluminum injection molded part) or as a deep drawn component with little effort and expense.

### ADVANTAGEOUS EFFECTS

In an advantageous configuration of the invention, the one supporting element or the plurality of supporting elements of the metallic formed part simultaneously provides for a connection to a fixing material, which likewise belongs to the metallic formed part. A connection of the gear wheel to a corresponding shaft or axle can be implemented via said fixing material. In this case, the plastic material essentially serves to stabilize the metallic formed part, respectively to advantageously reduce the vibration levels, and thereby provides for an effective reduction in noise. The metallic formed part is in contrast exclusively decisive for fulfilling the demands of dimensional accuracy and wear resistance.

In an additional advantageous configuration, supporting elements connected to the gear rim of the metallic formed part are not in direct contact with the respective shaft or axle, which serves to accept the gear wheel according to the invention. This shaft or axle is in this case connected to a plastic formed part, which constitutes the plastic filling according to the invention. Said part can be connected to the metallic formed part, which has the gear rim required for the operation of the gear wheel, in regions spaced apart from the shaft or axle. This connection between the metallic formed part and the plastic formed part can in turn take place in a positively locking manner by means of the appropriate connecting elements and/or in a different manner. In such an embodiment, the plastic formed part serves to fix the entire gear wheel to an associated shaft or axle in addition to having the effects already mentioned. Said part is consequently directly included in the flow of forces within a gear unit.

### BRIEF DESCRIPTION OF THE DRAWINGS

The invention is explained in detail with the aid of examples of embodiment. The following are shown:

FIG. 1 a top view of a metallic formed part according to the invention with a gear rim and inner rim for accepting an output shaft;

FIG. 2 a lateral view of the metallic formed part from FIG. 1 in sectional view;

FIG. 3 a lateral view of a gear wheel according to the invention with the metallic formed part from FIG. 1;

FIG. 4 a lateral view of the gear wheel according to the invention from FIG. 3 with a press-fitted output shaft;

FIG. 5 a cut-out of a metallic formed part according to the invention, in the region of the connection to a press-fitted output shaft;

FIG. 6 a top view of a metallic formed part according to the invention with supporting elements running into the inside region of the gear rim;

FIG. 7 a lateral view of the metallic formed part from FIG. 6;

FIG. 8 a lateral view of a gear wheel according to the invention with the metallic formed part from FIG. 6;

FIG. 9 a top view of a metallic formed part according to the invention with a gear rim without an inner rim;

FIG. 10 a lateral view of the metallic formed part from FIG. 9 with a connecting element, which partially runs into the inside region of the gear rim,

FIG. 11 an output shaft with a fitted gear shaped plastic formed part; and

FIG. 12 a lateral view of a gear wheel according to the invention with the metallic formed part from FIG. 9 and the plastic formed part from FIG. 11.

### DETAILED DESCRIPTION

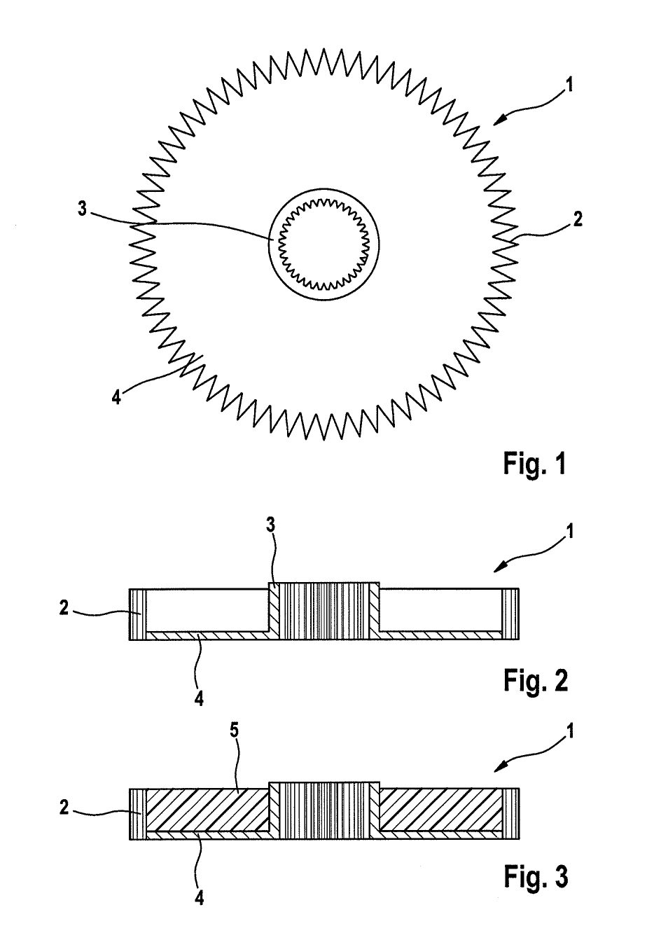

FIG. 1 shows a top view of a metallic formed part 1 with a gear rim 2 and a fixing material in the form of an inner rim 3 for accepting an output shaft. FIG. 2 shows the associated cut-out through the metallic formed part 1. The metallic formed part 1 has a circumferential gear rim 2 with outer gearing, which allows for the positively locking connection to additional gear unit elements. The central region of the metallic formed part 1 is composed from an inner rim 3 in the form of a socket, which can be attached to an output shaft in a force- and/or positively locking manner. The connection between the inner rim 3 and the gear rim 2 is produced by means of a supporting element 4 in the form of a rigid surface. The supporting element 4 simultaneously constitutes in this case a connecting element between the fixing material and the gear rim 2. A substantial reduction in the material requirements for the metallic formed part 1 results from a small thickness of this supporting element 4 even when the gear rim 2 and the inner rim 3 are generously dimensioned. This is accompanied by a corresponding weight savings. Formed parts of this kind can be used especially for gear units, with which torques are transferred, which do not require a massive embodiment of the gear wheels out of metal. In the present example of embodiment the connection between the gear rim and the inner rim results from an asymmetrical connection of the supporting element 4. Said connection can initially lead to an uneven deformation of the gear rim 2 and to a corresponding development of restoring forces in the region of the gear rim 2.

FIG. 3 shows a lateral view of a gear wheel according to the invention with the metallic formed part 1 from FIG. 1, the inside region of the metallic formed part 1 being filled with a plastic filling 5. In the present example, the filling of the inner region of the metallic formed part 1 takes place through casting with a plastic material, whereby a plastic formed part is formed with a geometry tailored exactly to the metallic formed part 1. The construction of the plastic filling can also, however, alternatively take place through a production of a plastic formed part that is independent of the metallic formed part 1, said construction occurring before the plastic filling 5 and the metallic formed part 1 are brought into connection with each other. The plastic filling 5 provides for a sufficient bracing of the gear rim 2 when the gear wheel is loaded, also in the case of an asymmetrical construction of the supporting element 4. The plastic filling 5 at least partially absorbs recurrent compressive loads. Furthermore, the plastic filling 5 reduces the vibration levels of a gear wheel according to the invention and consequently serves to effectively dampen noises.

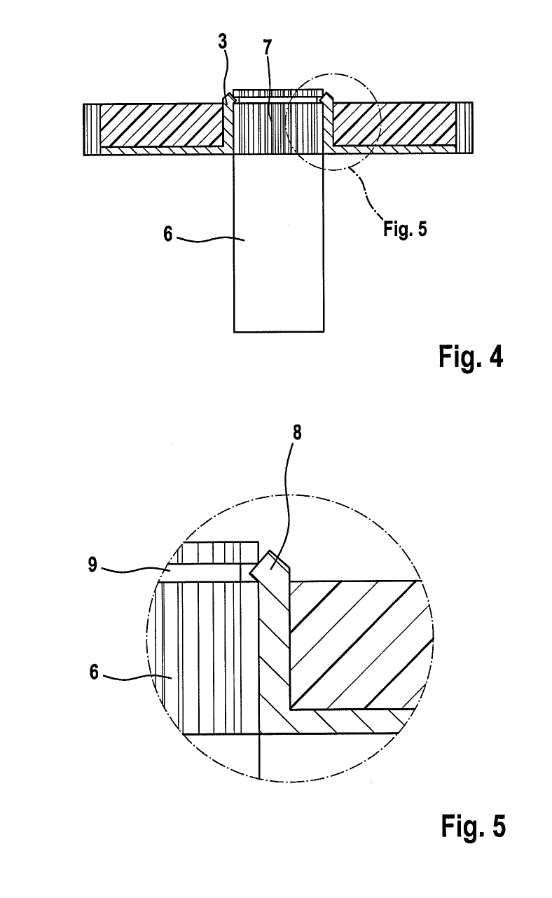

FIG. 4 shows a lateral view of the gear wheel according to the invention from FIG. 3 with an output shaft 6, which is press-fitted into the inner rim 3, of a washer drive, the gear wheel being depicted in the form of a cross-sectional view. The region of the output shaft 6, which is inserted into the inner rim 3 of the gear wheel, has grooves 7 running in the direction of insertion, whereby a good protection against a rotation of the gear wheel with respect to the output shaft 3 is achieved. At the same time, the region of the output shaft 6, which is inserted into the inner rim 3 of the gear wheel, has a slightly reduced diameter with respect to the rest of the output shaft 6, whereby a stop arises when the gear wheel is mounted. This facilitates a quick mounting of a gear wheel according to the invention during the assembly of a gear unit.

FIG. 5 shows an enlarged cut-out of the metallic formed part 1 according to the invention in the region of the connection with a press-fitted output shaft 6. The inner rim 3 has a retaining element 8 on its inside, which consists of a slightly bent down edge in the present example. At the same time, the output shaft 6 has a circumferential groove 9, in which the retaining element 8, i.e. the bent down edge area of the inner rim, engages after the gear wheel is connected to the output shaft 6 and is located in the end position. In this way, a protection against the output shaft 6 axially pulling out of the inner rim 3 of the gear wheel is implemented.

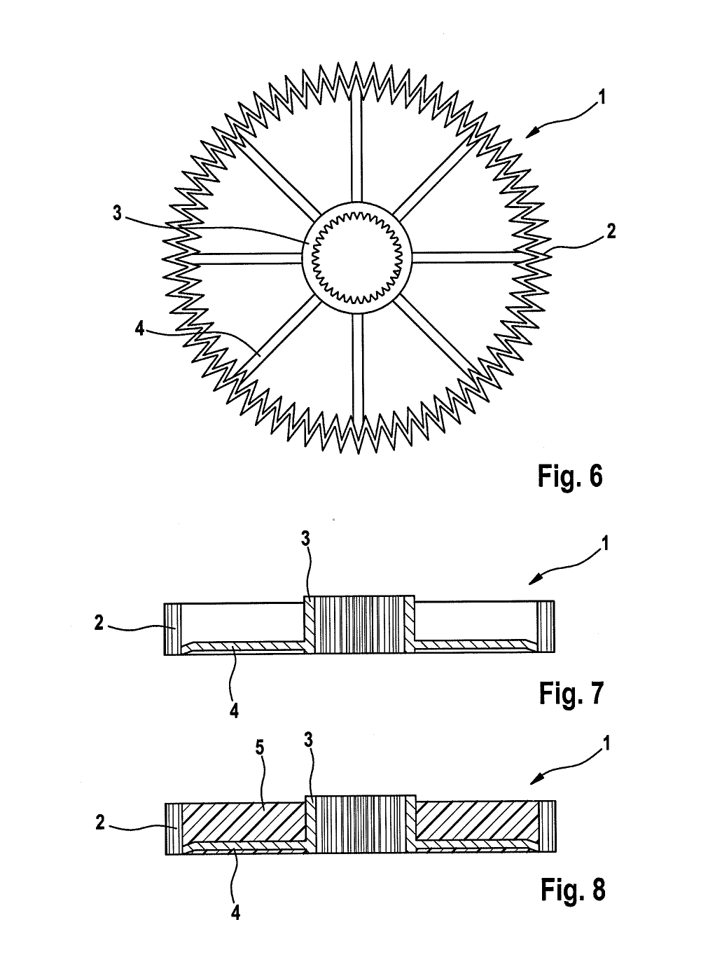

FIG. 6 shows a top view of a metallic formed part 1 according to the invention with the supporting elements 4 running into the inner region of the gear rim 2. The metallic formed part has again a circumferential gear rim 2, and the central region of the gear rim 2 of the formed part 1 is formed in turn from an inner rim 3 in the form of a socket, which can be mounted onto an output shaft in a force- and/or positively locking manner. The connection between the gear rim 2 and the inner rim 3 is carried out, however, by a plurality of supporting elements 4, which are embodied as braces running radially from the inner rim 3 to the gear rim 2. In this way, a particularly material-saving embodiment of the metallic formed part 1 can be implemented. When the rigidity of the gear rim 2 is sufficient, an excellent dimensional accuracy can, however, be implemented just like in the first example of embodiment.

FIGS. 7 and 8 show in each case a lateral sectional view of the metallic formed part 1 from FIG. 6, the metallic formed part 1 being already complemented with a plastic filling 5 to form a gear wheel according to the invention. An embodiment of the supporting elements 4, where said elements have bent down edges, can be seen in the lateral view. The connection of the gear rim 2 to the supporting elements 4 occurs in turn asymmetrically in the lower edge area of the gear rim 2. The connection of the supporting elements 4 to the inner rim 3 occurs in a central region, however likewise slightly asymmetrically. The plastic filling 5 fills the complete remaining volume within the gear rim 2. The supporting elements 4 and their connection are almost completely embedded in the plastic filling 5 by means of the supporting elements 4 and their connection being embodied in a bent over manner in a relatively central region of the inner rim 2. In this particular embodiment, the metallic formed part 1 is embedded in a pourable plastic. The complete embedding is connected in an advantageous manner with an especially secure connection between the metallic formed part 1 and the plastic formed part emerging by means of casting. It is thereby important that at least one supporting element 4 is included, which has a region whose cross-section is completely enclosed by the plastic filling 5. The embodiment of the supporting elements 4 in a bent over manner furthermore provides for an acoustical decoupling of the gear rim 2 from the inner rim 3, whereby the sound dampening effect of the plastic filling 5 is advantageously supported and a transfer of running noises to other parts of the gear unit is impeded.

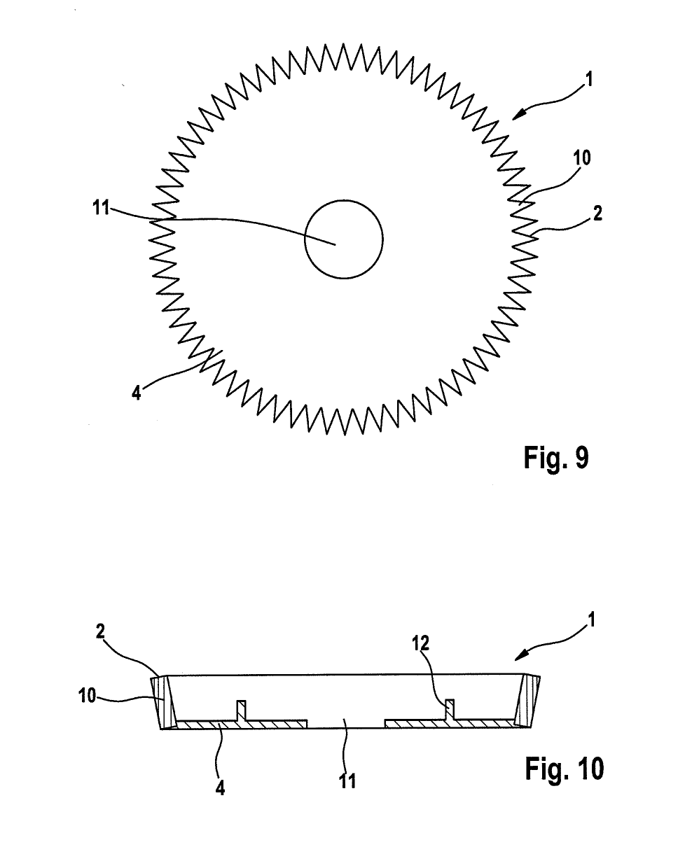

FIG. 9 shows a top view of a metallic formed part according to the invention with a gear rim 2 without an inner rim. The gear rim 2 has a conical gearing 10 on its outside as well as on its inside. The lower edge of the gear rim merges into a supporting element 4 in the form of a planar surface, which extends from the gear rim 4 inwards in the direction of the gear wheel and vertically to the rotational axis of said wheel. In the central region of the planar surface, a circular opening 11 is recessed, whose diameter is significantly larger than the diameter of the output shaft provided for fixing the gear wheel.

FIG. 10 shows a lateral view of the metallic formed part 1 from FIG. 9. The supporting element 4, which partially extends into the inside region of the gear rim in the form of a planar surface, is once again very visible. Connecting elements in the form of fixed pins 12 are arranged on this planar surface.

FIG. 11 shows an output shaft 6 with a mounted, gear-wheel shaped plastic formed part 5 in a lateral sectional view, which constitutes the plastic filling in the case of a finished gear wheel. This plastic formed part 5 has a conical gearing 13 on its outer edge, which can engage in a positively locking manner with the conical gearing 10 on the inside of the gear rim 2 of the metallic formed part 1 according to FIGS. 9 and 10. The central region of the plastic formed part 5 has fixed contact with the end of the output shaft 6. The plastic formed part 5 has cylindrical openings 14 on its under side, in which the pins 12 of a corresponding metallic formed part 1, which act as connecting elements, can engage.

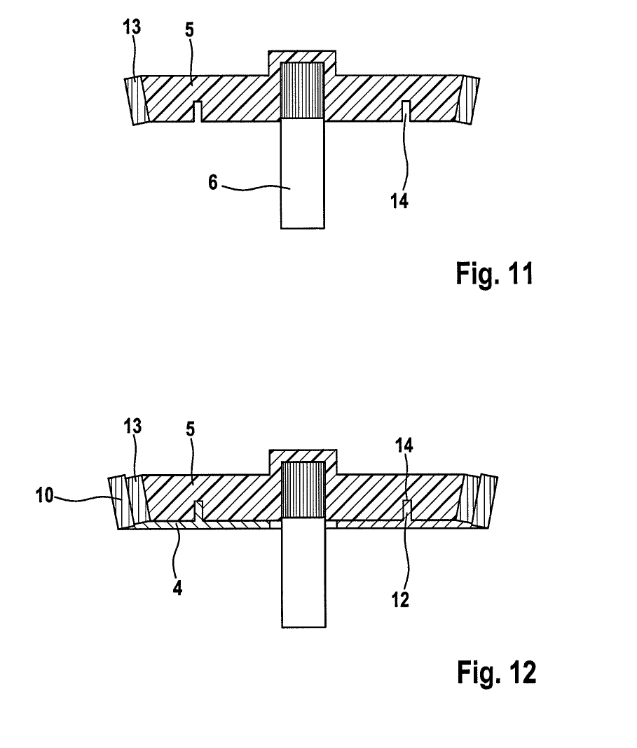

FIG. 12 shows a lateral view of a gear wheel according to the invention, which is composed of a metallic formed part 1 according to FIG. 9 and a plastic formed part 5 according to FIG. 11. The conical gearing 13 on the outside edge of the plastic formed part 5 meshes with the conical gearing 10 on the inside of the gear rim 2 of the metallic formed part 1. The fixed pins 12 on the supporting element 4 of the metallic formed part 1 are inserted into the corresponding cylindrical openings 14 on the under side of the plastic formed part 5. In so doing, a positively locking connection between the two components 1 and 5 is produced.

The planar supporting element 4 of the metallic formed part 1 has planar contact with the under side of the plastic formed part 5. A configuration of this kind makes provision for a reliable end stop during assembly of the two components 1, 5 to form the gear wheel according to the invention. This provision significantly facilitates a final assembly in the case of a mutually independent prefabrication of the plastic filling 5 as a plastic formed part and the metallic formed part 1. The fixed pins 12 and the corresponding cylindrical openings 14 are dimensioned in such a way that a force-locking connection additionally results between the two components 1, 5 during insertion. At least a temporary fixing of the two components is thereby produced. This force-locking connection is advantageously supplemented by additional connecting techniques, for example by gluing, whereby a secure connection of the two formed parts 1, 5 as components of the gear wheel according to the invention and a high functional safety of the gear wheel can be achieved.

1-10. (canceled)

11. A two-component gear wheel, comprising:
a metallic formed part made of a gear rim with outer gearing and at least one supporting element connected to the gear rim on an inside of the gear rim; and
a plastic filling that has planar contact at least in some regions with the inside of the gear rim.

12. The gear wheel of claim 11, wherein the metallic formed part comprises a fixing material used to implement a connection of the gear wheel to a shaft, wherein at least one supporting element connects the fixing material to the gear rim.

13. The gear wheel of claim 12, wherein the metallic formed part comprises a fixing material with an inner rim.

14. The gear wheel of claim 11, wherein the metallic formed part has as a supporting element a surface element vertical to a rotational axis of the gear wheel.

15. The gear wheel of claim 12, wherein the metallic formed part has as at least one supporting element braces running radially that connect the fixing material to the gear rim.

16. The gear wheel of claim 11, wherein the at least one supporting element is included therein that has a region comprising a cross-section completely enclosed by the plastic filling.

17. The gear wheel of claim 11, wherein a fixing material is included therein that has a retaining element that prevents the gear wheel from detaching.

18. The gear wheel of claim 11, wherein the plastic filling is a plastic formed part that is connected to the shaft that accepts the gear wheel.

19. The gear wheel of claim 18, wherein the plastic formed part is connected to the metallic formed part in regions spaced apart from the shaft.

20. The gear wheel of claim 18, wherein the plastic formed part is connected to the metallic formed part in a positively locking manner in regions spaced apart from the shaft.
